(19) United States
(12) Patent Application Publication
(10) Pub. No.: US 2013/0315109 A1
(43) Pub. Date: Nov. 28, 2013

(54) Outband/Inband or Full-Duplex/Half-Duplex Mixture Backhaul Signaling in Relay Enhanced Networks

(71) Applicants: Bernhard Raaf, Neuried (DE); Zhuyan Zhao, Beijing (CN); Zhenhong Li, Shanghai (CN); Jianke Fan, Espoo (FI)

(72) Inventors: Bernhard Raaf, Neuried (DE); Zhuyan Zhao, Beijing (CN); Zhenhong Li, Shanghai (CN); Jianke Fan, Espoo (FI)

(73) Assignee: NOKIA CORPORATION, Espoo (FI)

(21) Appl. No.: 13/704,916

(22) PCT Filed: Jun. 21, 2010
(86) PCT No.: PCT/CN2010/000904

§ 371 Date: Jun. 24, 2013

(51) Int. Cl. H04L 5/14

(52) U.S. Cl. CPC H04L 5/14
USPC 370/277

(57) ABSTRACT

It is provided an apparatus, comprising relaying means configured to form an instance of a fourth signal based on an instance of a first signal and to form an instance of a second signal based on an instance of a third signal; second receiving means configured to receive instances of the third signal from a terminal of a communication network in a second frequency band; and second transmitting means configured to transmit instances of the fourth signal to the terminal in a first frequency band; wherein the apparatus further comprises at least one of a combining means configured to combine an instance of a first signal part and an instance of a fourth signal part into an instance of the first signal and a splitting means configured to split an instance of the second signal into an instance of a second signal part and an instance of a third signal part; wherein, if the apparatus comprises the combining means, it comprises further first receiving means configured to receive an instance of the first signal part from a transceiver station of the communication network in the first frequency band, and to receive an instance of the fourth signal part in a fourth frequency band different from the first frequency band; and, if the apparatus comprises the splitting means, it comprises further first transmitting means configured to transmit an instance of the second signal part to the transceiver station in the second frequency band and to transmit an instance of the third signal part in a third frequency band different from the second frequency band.

### FIELD OF THE INVENTION

The present invention relates to an apparatus, a method, a system, and a computer program product related to backhaul signaling in a relay enhanced network. More particularly, the present invention relates to an apparatus, a method, a system, and a computer program product for outband/inband or full-duplex/half-duplex mixture backhaul signaling in relay enhanced networks.

### BACKGROUND OF THE INVENTION

Relay is a technique to improve system throughput and to extend the coverage. Relay Nodes (RNs) help enhanced NodeB (eNB) to communicate with user equipments (UE) that are located at the cell edge by forwarding the data from the UE to the eNB and vice versa. For further details, see 3^{rd} generation partnership project (3GPP) technical report (TR) 36.814, “Further Advancements for E-UTRA Physical Layer Aspects” (Chapter 9).

In a relay configuration, the link between eNB and RN is named backhaul link, and the link between eNB or RN on one side and UE on the other side is named as access link. Furthermore, an eNB in a relay configuration is also named donor eNB (DeNB). The connection of backhaul and access link can be done either inband or outband way depending on:
backhaul link eNB—RN operates in the same carrier frequency as the link between RN and UE (=inband);
backhaul link eNB—RN operates in a different carrier frequency than the link between RN and UE (=outband).

In the ongoing standardization activities of the 3^{rd} generation partnership project (3GPP) both inband and outband configurations are considered. Usually the study for inband and outband relay is independent, see e.g. 3GPP R1-082575, “Proposals for LTE-Advanced Technologies”.

In an inband relay configuration, as the backhaul link and access link are located in the same frequency band, unless sufficient isolation of the outgoing and incoming signals is provided, the self loop interference will prevent the relay node from performing transmission and reception simultaneously. Therefore, in an inband configuration, a RN usually works in half duplex mode.

In the context of relaying, the term half “half duplex” means that data on both backhaul link and access link are not sent/received in one direction (uplink or downlink) simultaneously. On the other hand, the term “full duplex” means that data on both backhaul link and access link are sent/received in one direction (uplink or downlink) simultaneously. Note that these meanings are different from the meanings of these terms in non-relaying applications, where theses terms relate to (non-)simultaneous transmission in uplink and downlink directions on the same link.

When such a RN receives data from the DeNB, a multimedia broadcast over single frequency network (MBSFN) subframe is transmitted by the RN, this subframe contains a large empty portion during which the RN does not transmit any signals and therefore can receive from the DeNB. As RN can not receive DPCCH of 3GPP release 8 (Rel8) during MBSFN subframe transmission, because at the beginning of the subframe the control part of the MBSFN subframe has to be transmitted by the RN, new control channel and procedure are needed to support backhaul link operation.

With respect to outband relay, if backhaul link and access link are isolated enough in frequency, then there is no interference issue in the two links if they are operating simultaneously. Therefore, outband relay can work at “full duplex transmission mode”. When outband relay supports full duplex transmission, it is possible that the backhaul link reuses the channels designed for the access, i.e. for an Rel8 UE. In this case, introduction of relay links will have no or only little impact to the Rel8 standard. This will reduce the development complexity for relay.

In an inband relay, backhaul and access link operate on the same frequency carrier and are separated in time for reducing interference between the two links. RN may not be able to receive from one side and to transmit to the other side simultaneously (half duplex operation). If there is a concurrent operation request of the backhaul and the access links, RN has to delay one side operation or halt the signaling. This is so called backhaul and access link collision and it has been regarded as one of the issues to be solved for current inband schemes in both time division duplex (TDD) and frequency division duplex (FDD) mode.

For example, the hybrid automatic repeat request (HARQ) timing is planed to be based on 8&16 ms periodicity. Since the MBSFN subframe signalling is (typically) periodic with a period 10 ms and the Rel-8 UL HARQ timing is synchronous with 8 ms periodicity, there may be collision between the UL backhaul subframe transmission and UL access subframe reception at the RN. If not resolved, the collision may lead to lost acknowledgements and lost grants at the eNB and the RN, thus impacting performance. In TDD the collision problem might be more serious than in FDD due to limited resources in the frame format.

Another issue with current inband relay schemes might be that in both TDD and FDD, there are unblankable subframes such as (0, 1, 5, 6) for TDD and (0, 4, 5, 9) for FDD subframes, which cannot be used for backhaul because they are used to transmit primary synchronization signal (PSS), secondary synchronization signal (SSS), physical broadcast channel (PBCH) and paging signal. This could be seen as collisions in DL subframe in the backhaul link.

The HARQ collision is exampled as in FIG. 1, taken from 3GPP R1-100346, “FDD HARQ Issues over Un with 8 ms SF Periodicity”.

According to this example, it is assumed that an uplink (UL) subframe, that is related with a non-MBSFN sub-frame (SF) (#0, #4, #5, #9 for FDD), will be allocated to the UL backhaul link. Non-MBSFN sub-frames (#0, #4, #5, #9) will be used for the relay access link to avoid a waste of resources. HARQ requires that acknowledgement (ACK) or non-acknowledgement (NACK) is sent 4 sub-frames later. Thus, the relay access link will require UL ACK/NACK feedback in UL subframes (#3, #4, #8, #9) assuming 10 subframes in a frame. UL subframes #3, #4, #8, #9 are allocated to UL backhaul transmission, too. Thus, there may be a collision between access link and backhaul link that might cause loss of HARQ information.

In order to have less collision between backhaul link and access link, it is proposed in 3GPP R1-100346 that an UL subframe that is related with a non-MBSFN sub-frame (#0, #4, #5, #9 for FDD, #0, #1, #5, #6 for TDD) will not be allocated to the UL backhaul link.

The HARQ collision problem is directly related to access-backhaul resource partition for inband relay, which might be an implicit configuration for FDD and an explicit configuration for TDD. However, these configuration methods still can not avoid the HARQ collision problem.

Furthermore, in 3GPP R1-100340, “Improved Access-backhaul Partition Scheme for TDD Relay”, three methods are considered for solving the HARQ collision issue for inband relay by playing the following slot-wised method on access-backhaul resource partition:
1) Receiving half PUCCH to obtain uplink feedback
2) Receiving half PUSCH to obtain uplink feedback
3) Receiving ACK/NACK from PUSCH or PUCCH.

These methods are viable solutions for an inband system although they still have drawbacks as it is analyzed in the above mentioned document such as:

1) ACK/NACK performance loss due to repletion gain and due to frequency-hopping gain being not available anymore.

2) Capacity of ACK/NACK for different R-UEs is not so large because there can be only one UE per PRB(s) allocated for the PUSCH.

3) Considerable inter-Relay interference.

Relay with carrier aggregation is discussed in 3GPP R1-091332, “Carrier Aggregation Considerations for Relays”, and WO 2009/149565. In 3GPP R1-091332, it is described that the number of component carriers (CCs) in backhaul and access link can be dynamically scheduled. In WO 2009/149565 (claims 15 and 20 and similar claims), it is proposed a relay outband feature, so that in relay, the access link and backhaul link are operated simultaneously, and dynamically assigning at least one of the first and third sub-band to a different sub-band than the dedicated first or third frequency sub-band (claim 20).

### SUMMARY OF THE INVENTION

It is an object of the present invention to improve the prior art.

According to a first aspect of the invention, there is provided an apparatus, comprising relaying means configured to form an instance of a fourth signal based on an instance of a first signal and to form an instance of a second signal based on an instance of a third signal; second receiving means configured to receive instances of the third signal from a terminal of a communication network in a second frequency band; and second transmitting means configured to transmit instances of the fourth signal to the terminal in a first frequency band; wherein the apparatus further comprises at least one of a combining means configured to combine an instance of a first signal part and an instance of a fourth signal part into an instance of the first signal and a splitting means configured to split an instance of the second signal into an instance of a second signal part and an instance of a third signal part; wherein, if the apparatus comprises the combining means, it comprises further first receiving means configured to receive an instance of the first signal part from a transceiver station of the communication network in the first frequency band, and to receive an instance of the fourth signal part in a fourth frequency band different from the first frequency band; and, if the apparatus comprises the splitting means, it comprises further first transmitting means configured to transmit an instance of the second signal part to the transceiver station in the second frequency band and to transmit an instance of the third signal part in a third frequency band different from the second frequency band.

According to a second aspect of the invention, there is provided an apparatus, comprising relaying means configured to form an instance of a fourth signal based on an instance of a first signal and to form an instance of a second signal based on an instance of a third signal; second receiving means configured to receive instances of the third signal from a terminal of a communication network; and second transmitting means configured to transmit instances of the fourth signal to the terminal; wherein the apparatus further comprises at least one of a combining means configured to combine an instance of the first signal part and an instance of the fourth signal part into an instance of the first signal and a splitting means configured to split an instance of the second signal into an instance of the second signal part and an instance of the third signal part; wherein, if the apparatus comprises the combining means, it comprises further third receiving means configured to receive instances of the first signal part from a transceiver station of the communication network, fourth receiving means configured to receive instances of the fourth signal part from the transceiver station, and, first prohibiting means configured to permit the second transmitting means to transmit an instance of the fourth signal which is based on an instance of the fourth signal part and to simultaneously prohibit the fourth receiving means to receive an instance of the fourth signal part, and configured to prohibit the second transmitting means to transmit an instance of the fourth signal which is based on an instance of the fourth signal part and to simultaneously permit the fourth receiving means to receive an instance of the fourth signal part; and wherein the second transmitting means is configured to transmit the instance of the fourth signal which is based on an instance of the fourth signal part only when it is permitted to; if the apparatus comprises the splitting means, it comprises further third transmitting means configured to transmit instances of the third signal part to the transceiver station, fourth transmitting means configured to transmit instances of the second signal part to the transceiver station, and second prohibiting means configured to permit the fourth receiving means to transmit an instance of the third signal part and to simultaneously prohibit the second receiving means to receive an instance of the third signal, and configured to prohibit the fourth receiving means to transmit an instance of the third signal part and to simultaneously permit the second receiving means to receive an instance of the third signal, and wherein the fourth transmitting means is configured to transmit the instance of the third signal part only when it is permitted to.

In the apparatus according to the first or second aspect, the second signal may comprise a second control signal for controlling the transceiver station and a second data signal different from the second control signal; the second signal part of the second signal may comprise a first fraction of the second data signal; and the third signal part of the second signal may comprise a second fraction of the second data signal.

In the apparatus according to the first or second aspect, the first fraction and the second fraction may be predetermined.

The apparatus according to the first or second aspect may further comprise fifth receiving means configured to receive a splitting information from the transceiver station; and the splitting means may be further configured to split the second signal based on the splitting information.

In the apparatus according to the first or second aspect, the splitting information may be comprised in the first signal part or in a signaling of a higher protocol layer than a protocol layer of the first signal.

In the apparatus according to the first aspect, if the apparatus does not comprise the combining means, the first receiving means may be configured to receive the first signal in one of the first frequency band and the fourth frequency band; and, if the apparatus does not comprise the splitting means, the first transmitting means may be configured to transmit the second signal in one of the second frequency band and the third frequency band.

In the apparatus according to first or second aspect, if the apparatus comprises the splitting means, the second signal may comprise a second control signal for controlling the transceiver station and a second data signal different from the second control signal; the second signal part of the second signal may comprise either the second control signal or the second data signal; and the third signal part of the second signal may comprise the second control signal or second data signal which is not comprised in the second signal part; and if the apparatus comprises the combining means, the first signal may comprise a first control signal for controlling the apparatus and a first data signal different from the first control signal; the first signal part of the first signal may comprise either the first control signal or the first data signal; and the fourth signal part of the first signal may comprise the first control signal or the first data signal which is not comprised in the first signal part.

In the apparatus according to the first aspect, if the apparatus comprises the combining means, the first receiving means may comprise third receiving means configured to receive instances of the first signal part, fourth receiving means configured to receive instances of the fourth signal part, and the apparatus may comprise further first prohibiting means configured to prohibit the fourth receiving means from receiving an instance of the fourth signal part only when the second transmitting means transmits an instance of the fourth signal which is based on an instance of the fourth signal part; and if the apparatus comprises the splitting means, the first transmitting means may comprise third transmitting means configured to transmit instances of the third signal part, fourth transmitting means configured to transmit instances of the second signal part, and the apparatus may comprise further second prohibiting means configured to prohibit the second receiving means from receiving an instance of the third signal and to allow transmitting of an instance of the third signal part only when the second receiving means is prohibited to receive an instance of the third signal.

In the apparatus according to the second aspect, the second prohibiting means may be further configured to instruct the second transmitting means to send an instance of a fifth signal to the terminal when it prohibits the second receiving means from receiving, wherein the fifth signal is adapted to prohibit the terminal to send an instance of the third signal.

According to a third aspect of the invention, there is provided a relay node comprising an apparatus according to the first or second aspect.

According to a fourth aspect of the invention, there is provided an apparatus, comprising transceiver station means configured to provide a transceiver station functionality of a communication network; wherein the apparatus further comprises at least one of a combining means configured to combine an instance of a second signal part and an instance of a third signal part into an instance of a second signal and a splitting means configured to split an instance of a first signal into an instance of a first signal part and an instance of a fourth signal part; and wherein, if the apparatus comprises the splitting means, it comprises further first transmitting means configured to transmit instances of the first signal part to a relay node of the communication network in a first frequency band and to transmit instances of the fourth signal part in a fourth frequency band different from the first frequency band; and, if the apparatus comprises the combining means, it comprises further first receiving means configured to receive instances of the second signal part from the relay node in a second frequency band, and to receive instances of the third signal part in a third frequency band different from the second frequency band.

According to a fifth aspect of the invention, there is provided an apparatus, comprising transceiver station means configured to provide a transceiver station functionality of a communication network; wherein the apparatus further comprises at least one of a combining means configured to combine an instance of a second signal part and an instance of a third signal part into an instance of a second signal and a splitting means configured to split an instance of a first signal into an instance of a first signal part and an instance of a fourth signal part; and wherein, if the apparatus comprises the splitting means, it comprises further third transmitting means configured to transmit instances of the first signal part to a relay node of the communication network, fourth transmitting means configured to transmit instances of the fourth signal part to the relay node, and prohibiting means configured to prohibit the fourth transmitting means from transmitting an instance of the fourth signal part at a predetermined time; and, if the apparatus comprises the combining means, it comprises further third receiving means configured to receive instances of the second signal part from the relay node, and fourth receiving means configured to receive instances of the third signal part.

In the apparatus according to the fourth or fifth aspect, the second signal may comprise a second control signal for controlling the apparatus and a second data signal different from the second control signal; the second signal part of the second signal may comprise a first fraction of the second data signal; and the third signal part of the second signal may comprise a second fraction of the second data signal.

In the apparatus according to the fourth or fifth aspect, the first fraction and the second fraction may be predetermined.

The apparatus according to the fourth or fifth aspect may further comprise determining means configured to determine a splitting information based on an analysis of a potential collision between receiving a third signal and transmitting the second signal by the relay node; and third transmitting means configured to transmit the splitting information to the relay node as a portion of the first signal.

In the apparatus according to the fourth or fifth aspect, the splitting information may be comprised in the first signal part or in a signaling of a higher protocol layer than a protocol layer of the first signal.

In the apparatus according to the fourth aspect, if the apparatus does not comprise the combining means, the first receiving means may be configured to receive the second signal in one of the second frequency band and fourth frequency band; and if the apparatus does not comprise the splitting means, the first transmitting means may be configured to transmit the first signal in one of the first frequency band and the fourth frequency band.

In the apparatus according to the fourth or fifth aspect, if the apparatus comprises the combining means, the second signal may comprise a second control signal for controlling the apparatus and a second data signal different from the second control signal; the second signal part of the second signal may comprise either the second control signal or the second data signal; and the third signal part of the second signal may comprise the second control signal or second data signal which is not comprised in the second signal part; and if the apparatus comprises the splitting means, the first signal may comprise a first control signal for controlling the relay node and a first data signal different from the first control signal; the first signal part of the first signal may comprise either the first control signal or the first data signal; and the fourth signal part of the first signal may comprise the first control signal or the first data signal which is not comprised in the first signal part.

In the apparatus according to the fourth aspect, if the apparatus comprises the splitting means, the first transmitting means may comprise third transmitting means configured to transmit instances of the first signal part to a relay node of the communication network, and fourth transmitting means configured to transmit instances of the fourth signal part to the relay node, the apparatus may comprise further prohibiting means configured to prohibit the second transmitting means from transmitting an instance of the fourth signal part at a predetermined time.

According to a sixth aspect of the invention, there is provided a transceiver station comprising an apparatus according to the fourth or fifth aspect.

According to a seventh aspect of the invention, there is provided a system comprising a first apparatus according to any of the first, second, and third aspect and a second apparatus according to any of the fourth, fifth and sixth aspect, wherein, if the first apparatus comprises the splitting means, the second apparatus comprises the combining means, and the splitting means of the first apparatus is configured to split an instance of an uplink signal into an instance of the second signal part and an instance of the third signal part, and the combining means of the second apparatus is configured to combine the instance of the second signal part and the instance of the third signal part into the instance of the uplink signal; and wherein, if the first apparatus comprises the combining means, the second apparatus comprises the splitting means, and the splitting means of the second apparatus is configured to split an instance of the downlink signal into an instance of the first signal part and an instance of the fourth signal part, and the combining means of the first apparatus is configured to combine the instance of the first signal part and the instance of the fourth signal part into the instance of the downlink signal.

According to an eighth aspect of the invention, there is provided a method, comprising forming, by an apparatus, an instance of a fourth signal based on an instance of a first signal and forming an instance of a second signal based on an instance of a third signal; receiving, by the apparatus, instances of the third signal from a terminal of a communication network in a second frequency band; and transmitting, by the apparatus, instances of the fourth signal to the terminal in a first frequency band; wherein the method further comprises at least one of combining, by the apparatus, an instance of a first signal part and an instance of a fourth signal part into an instance of the first signal and splitting, by the apparatus, an instance of the second signal into an instance of a second signal part and an instance of a third signal part; wherein, if the method comprises the combining, it comprises further receiving, by the apparatus, an instance of the first signal part from a transceiver station of the communication network in the first frequency band, and receiving an instance of the fourth signal part in a fourth frequency band different from the first frequency band; and, if the method comprises the splitting, it comprises further transmitting, by the apparatus, an instance of the second signal part to the transceiver station in the second frequency band and transmitting an instance of the third signal part in a third frequency band different from the second frequency band.

The method according to the eighth aspect may be a method of outband/inband mixture backhaul signaling.

According to a ninth aspect of the invention, there is provided a method, comprising forming, by an apparatus, an instance of a fourth signal based on an instance of a first signal; forming, by the apparatus, an instance of a second signal based on an instance of a third signal; receiving, by the apparatus, instances of the third signal from a terminal of a communication network; transmitting, by the apparatus, instances of the fourth signal to the terminal; wherein the method further comprises at least one of combining an instance of the first signal part and an instance of the fourth signal part into an instance of the first signal and splitting an instance of the second signal into an instance of the second signal part and an instance of the third signal part; wherein, if the method comprises the combining, it comprises further receiving instances of the first signal part from a transceiver station of the communication network, receiving instances of the fourth signal part from the transceiver station, and permitting the transmitting of an instance of the fourth signal which is based on an instance of the fourth signal part simultaneous with prohibiting the receiving of an instance of the fourth signal part, and prohibiting the transmitting of an instance of the fourth signal which is based on an instance of the fourth signal part simultaneous with permitting the receiving of an instance of the fourth signal part, and wherein the instance of the fourth signal which is based on an instance of the fourth signal part is transmitted only when it is permitted; if the method comprises the splitting, it comprises further transmitting instances of the third signal part to the transceiver station, transmitting instances of the second signal part to the transceiver station, permitting transmitting of an instance of the third signal part simultaneous with prohibiting receiving an instance of the third signal, and prohibiting transmitting of an instance of the third signal part simultaneous with permitting receiving an instance of the third signal, and wherein the instance of the third signal part is only transmitted when it is permitted.

The method according to the ninth aspect may be a method of half-duplex/full-duplex mixture backhaul signaling.

In the method according to the eighth or ninth aspect, the second signal may comprise a second control signal for controlling the transceiver station and a second data signal different from the second control signal; the second signal part of the second signal may comprise a first fraction of the second data signal; and the third signal part of the second signal may comprise a second fraction of the second data signal.

In the method according to the eighth or ninth aspect, the first fraction and the second fraction may be predetermined.

The method according to the eighth or ninth aspect may further comprise receiving, by the apparatus, a splitting information from the transceiver station; and the splitting of the second signal may be based on the splitting information.

In the method according to the eighth or ninth aspect, the splitting information may be comprised in the first signal part or in a signaling of a higher protocol layer than a protocol layer of the first signal.

In the method according to the eighth aspect, if the method does not comprise the combining, the first signal may be received in one of the first frequency band and the fourth frequency band; and, if the method does not comprise the splitting, the second signal may be transmitted in one of the second frequency band and the third frequency band.

In the method according to the eighth or ninth aspect, if the apparatus comprises the splitting means, the second signal may comprise a second control signal for controlling the transceiver station and a second data signal different from the second control signal; the second signal part of the second signal may comprise either the second control signal or the second data signal; and the third signal part of the second signal may comprise the second control signal or second data signal which is not comprised in the second signal part; and if the apparatus comprises the combining means, the first signal may comprise a first control signal for controlling the apparatus and a first data signal different from the first control signal; the first signal part of the first signal may comprise either the first control signal or the first data signal; and the fourth signal part of the first signal may comprise the first control signal or the first data signal which is not comprised in the first signal part.

In the method according to the eighth aspect, if the method comprises the combining, the method may comprise permitting the transmitting of an instance of the fourth signal which is based on an instance of the fourth signal part simultaneous with prohibiting the receiving of an instance of the fourth signal part, and prohibiting the transmitting of an instance of the fourth signal which is based on an instance of the fourth signal part simultaneous with permitting the receiving of an instance of the fourth signal part, and wherein the instance of the fourth signal which is based on an instance of the fourth signal part is transmitted only when it is permitted; and wherein, if the method comprises the splitting, the method may comprise permitting transmitting of an instance of the third signal part simultaneous with prohibiting receiving an instance of the third signal, and prohibiting transmitting of an instance of the third signal part simultaneous with permitting receiving an instance of the third signal, and wherein the instance of the third signal part is only transmitted when it is permitted.

According to a tenth aspect of the invention, there is provided a method, comprising providing, by an apparatus, a transceiver station functionality of a communication network; wherein the method further comprises at least one of combining, by the apparatus, an instance of a second signal part and an instance of a third signal part into a second signal and splitting, by the apparatus, an instance of a first signal into an instance of a first signal part and an instance of a fourth signal part; and wherein, if the method comprises the splitting, it comprises further transmitting, by the apparatus, instances of the first signal part to a relay node of the communication network in the first frequency band and transmitting instances of the fourth signal part in a fourth frequency band different from the first frequency band; and, if the method comprises the combining, it comprises further receiving, by the apparatus, instances of the second signal part from the relay node in the second frequency band, and receiving instances of the third signal part in a third frequency band different from the second frequency band.

The method according to the tenth aspect may be a method of outband/inband mixture backhaul signaling.

According to an eleventh aspect of the invention, there is provided a method, comprising providing a transceiver station functionality of a communication network; wherein the method further comprises at least one of combining an instance of a second signal part and an instance of a third signal part into an instance of a second signal and splitting an instance of a first signal into an instance of a first signal part and an instance of a fourth signal part; and wherein, if the method comprises the splitting, it comprises further transmitting instances of the first signal part to a relay node of the communication network, transmitting instances of the fourth signal part to the relay node, and prohibiting transmitting an instance of the fourth signal part at a predetermined time; and, if the method comprises the combining, it comprises further receiving instances of the second signal part from the relay node, and receiving instances of the third signal part.

The method according to the eleventh aspect may be a method of half-duplex/full-duplex mixture backhaul signaling.

In the method according to the tenth or eleventh aspect, the second signal may comprise a second control signal for controlling the apparatus and a second data signal different from the second control signal; the second signal part of the second signal may comprise a first fraction of the second data signal; and the third signal part of the second signal may comprise a second fraction of the second data signal.

In the method according to the tenth or eleventh aspect, the first fraction and the second fraction may be predetermined.

The method according to the tenth or eleventh aspect may further comprise determining, by the apparatus, a splitting information based on an analysis of a potential collision between receiving the third signal and transmitting the second signal; and transmitting the splitting information to the relay node as a portion of the first signal.

In the method according to the tenth or eleventh aspect, the splitting information may be comprised in the first signal part or in a signaling of a higher protocol layer than a protocol layer of the first signal.

In the method according to the tenth aspect, if the method does not comprise the combining, the second signal may be received in one of the second frequency band and fourth frequency band; and if the method does not comprise the splitting, the first signal may be transmitted in one of the first frequency band and the fourth frequency band.

In the method according to the tenth or eleventh aspect, if the apparatus comprises the combining means, the second signal may comprise a second control signal for controlling the apparatus and a second data signal different from the second control signal; the second signal part of the second signal may comprise either the second control signal or the second data signal; and the third signal part of the second signal may comprise the second control signal or second data signal which is not comprised in the second signal part; and if the apparatus comprises the splitting means, the first signal may comprise a first control signal for controlling the relay node and a first data signal different from the first control signal; the first signal part of the first signal may comprise either the first control signal or the first data signal; and the fourth signal part of the first signal may comprise the first control signal or the first data signal which is not comprised in the first signal part.

According to a twelfth aspect of the invention, there is provided a computer program product comprising computer-executable components which perform, when the program is run on a computer, the execution of which result in operations of the method according to any of the eighth, ninth, tenth, and eleventh aspects.

The computer program product according to the twelfth aspect may be embodied as a computer-readable storage medium.

According to a thirteenth aspect of the invention, there is provided an apparatus, comprising relay processor configured to form an instance of a fourth signal based on an instance of a first signal and to form an instance of a second signal based on an instance of a third signal; second receiver configured to receive instances of the third signal from a terminal of a communication network in a second frequency band; and second transmitter configured to transmit instances of the fourth signal to the terminal in a first frequency band; wherein the apparatus further comprises at least one of a combiner configured to combine an instance of a first signal part and an instance of a fourth signal part into an instance of the first signal and a splitter configured to split an instance of the second signal into an instance of a second signal part and an instance of a third signal part; wherein, if the apparatus comprises the combiner, it comprises further first receiver configured to receive an instance of the first signal part from a transceiver station of the communication network in the first frequency band, and to receive an instance of the fourth signal part in a fourth frequency band different from the first frequency band; and, if the apparatus comprises the splitter, it comprises further first transmitter configured to transmit an instance of the second signal part to the transceiver station in the second frequency band and to transmit an instance of the third signal part in a third frequency band different from the second frequency band.

According to a fourteenth aspect of the invention, there is provided an apparatus, comprising relay processor configured to form an instance of a fourth signal based on an instance of a first signal and to form an instance of a second signal based on an instance of a third signal; second receiver configured to receive instances of the third signal from a terminal of a communication network; and second transmitter configured to transmit instances of the fourth signal to the terminal; wherein the apparatus further comprises at least one of a combiner configured to combine an instance of the first signal part and an instance of the fourth signal part into an instance of the first signal and a splitter configured to split an instance of the second signal into an instance of the second signal part and an instance of the third signal part; wherein, if the apparatus comprises the combiner, it comprises further third receiver configured to receive instances of the first signal part from a transceiver station of the communication network, fourth receiver configured to receive instances of the fourth signal part from the transceiver station, and, first prohibitor configured to permit the second transmitter to transmit an instance of the fourth signal which is based on an instance of the fourth signal part and to simultaneously prohibit the fourth receiver to receive an instance of the fourth signal part, and configured to prohibit the second transmitter to transmit an instance of the fourth signal which is based on an instance of the fourth signal part and to simultaneously permit the fourth receiver to receive an instance of the fourth signal part; and wherein the second transmitter is configured to transmit the instance of the fourth signal which is based on an instance of the fourth signal part only when it is permitted to; if the apparatus comprises the splitter, it comprises further third transmitter configured to transmit instances of the third signal part to the transceiver station, fourth transmitter configured to transmit instances of the second signal part to the transceiver station, and second prohibitor configured to permit the fourth receiver to transmit an instance of the third signal part and to simultaneously prohibit the second receiver to receive an instance of the third signal, and configured to prohibit the fourth receiver to transmit an instance of the third signal part and to simultaneously permit the second receiver to receive an instance of the third signal, and wherein the fourth transmitter is configured to transmit the instance of the third signal part only when it is permitted to.

In the apparatus according to the thirteenth or fourteenth aspect, the second signal may comprise a second control signal for controlling the transceiver station and a second data signal different from the second control signal; the second signal part of the second signal may comprise a first fraction of the second data signal; and the third signal part of the second signal may comprise a second fraction of the second data signal.

In the apparatus according to the thirteenth or fourteenth aspect, the first fraction and the second fraction may be predetermined.

The apparatus according to the thirteenth or fourteenth aspect may further comprise fifth receiver configured to receive a splitting information from the transceiver station; and the splitter may be further configured to split the second signal based on the splitting information.

In the apparatus according to the thirteenth or fourteenth aspect, the splitting information may be comprised in the first signal part or in a signaling of a higher protocol layer than a protocol layer of the first signal.

In the apparatus according to the thirteenth aspect, if the apparatus does not comprise the combiner, the first receiver may be configured to receive the first signal in one of the first frequency band and the fourth frequency band; and, if the apparatus does not comprise the splitter, the first transmitter may be configured to transmit the second signal in one of the second frequency band and the third frequency band.

In the apparatus according to the thirteenth and fourteenth aspect, if the apparatus comprises the splitter, the second signal may comprise a second control signal for controlling the transceiver station and a second data signal different from the second control signal; the second signal part of the second signal may comprise either the second control signal or the second data signal; and the third signal part of the second signal may comprise the second control signal or second data signal which is not comprised in the second signal part; and if the apparatus comprises the combiner, the first signal may comprise a first control signal for controlling the apparatus and a first data signal different from the first control signal; the first signal part of the first signal may comprise either the first control signal or the first data signal; and the fourth signal part of the first signal may comprise the first control signal or the first data signal which is not comprised in the first signal part.

In the apparatus according to the thirteenth aspect, if the apparatus comprises the combiner, the first receiver may comprise third receiver configured to receive instances of the first signal part, fourth receiver configured to receive instances of the fourth signal part, and the apparatus may comprise further first prohibitor configured to prohibit the fourth receiver from receiving an instance of the fourth signal part only when the second transmitter transmits an instance of the fourth signal which is based on an instance of the fourth signal part; and if the apparatus comprises the splitter, the first transmitter may comprise third transmitter configured to transmit instances of the third signal part, fourth transmitter configured to transmit instances of the second signal part, and the apparatus may comprise further second prohibitor configured to prohibit the second receiver from receiving an instance of the third signal and to allow transmitting of an instance of the third signal part only when the second receiver is prohibited to receive an instance of the third signal.

In the apparatus according to the fourteenth aspect, the second prohibitor may be further configured to instruct the second transmitter to send an instance of a fifth signal to the terminal when it prohibits the second receiver from receiving, wherein the fifth signal is adapted to prohibit the terminal to send an instance of the third signal.

According to a fifteenth aspect of the invention, there is provided a relay node comprising an apparatus according to the thirteenth or fourteenth aspect.

According to a sixteenth aspect of the invention, there is provided an apparatus, comprising transceiver station processor configured to provide a transceiver station functionality of a communication network; wherein the apparatus further comprises at least one of a combiner configured to combine an instance of a second signal part and an instance of a third signal part into an instance of a second signal and a splitter configured to split an instance of a first signal into an instance of a first signal part and an instance of a fourth signal part; and wherein, if the apparatus comprises the splitter, it comprises further first transmitter configured to transmit instances of the first signal part to a relay node of the communication network in a first frequency band and to transmit instances of the fourth signal part in a fourth frequency band different from the first frequency band; and, if the apparatus comprises the combiner, it comprises further first receiver configured to receive instances of the second signal part from the relay node in a second frequency band, and to receive instances of the third signal part in a third frequency band different from the second frequency band.

According to a seventeenth aspect of the invention, there is provided an apparatus, comprising transceiver station processor configured to provide a transceiver station functionality of a communication network; wherein the apparatus further comprises at least one of a combiner configured to combine an instance of a second signal part and an instance of a third signal part into an instance of a second signal and a splitter configured to split an instance of a first signal into an instance of a first signal part and an instance of a fourth signal part; and wherein, if the apparatus comprises the splitter, it comprises further third transmitter configured to transmit instances of the first signal part to a relay node of the communication network, fourth transmitter configured to transmit instances of the fourth signal part to the relay node, and prohibitor configured to prohibit the fourth transmitter from transmitting an instance of the fourth signal part at a predetermined time; and, if the apparatus comprises the combiner, it comprises further third receiver configured to receive instances of the second signal part from the relay node, and fourth receiver configured to receive instances of the third signal part.

In the apparatus according to the sixteenth or seventeenth aspect, the second signal may comprise a second control signal for controlling the apparatus and a second data signal different from the second control signal; the second signal part of the second signal may comprise a first fraction of the second data signal; and the third signal part of the second signal may comprise a second fraction of the second data signal.

In the apparatus according to the sixteenth or seventeenth aspect, the first fraction and the second fraction may be predetermined.

The apparatus according to the sixteenth or seventeenth aspect may further comprise determiner configured to determine a splitting information based on an analysis of a potential collision between receiving a third signal and transmitting the second signal by the relay node; and third transmitter configured to transmit the splitting information to the relay node as a portion of the first signal.

In the apparatus according to the sixteenth or seventeenth aspect, the splitting information may be comprised in the first signal part or in a signaling of a higher protocol layer than a protocol layer of the first signal.

In the apparatus according to the sixteenth aspect, if the apparatus does not comprise the combiner, the first receiver may be configured to receive the second signal in one of the second frequency band and fourth frequency band; and if the apparatus does not comprise the splitter, the first transmitter may be configured to transmit the first signal in one of the first frequency band and the fourth frequency band.

In the apparatus according to the sixteenth or seventeenth aspect, if the apparatus comprises the combiner, the second signal may comprise a second control signal for controlling the apparatus and a second data signal different from the second control signal; the second signal part of the second signal may comprise either the second control signal or the second data signal; and the third signal part of the second signal may comprise the second control signal or second data signal which is not comprised in the second signal part; and if the apparatus comprises the splitter, the first signal may comprise a first control signal for controlling the relay node and a first data signal different from the first control signal; the first signal part of the first signal may comprise either the first control signal or the first data signal; and the fourth signal part of the first signal may comprise the first control signal or the first data signal which is not comprised in the first signal part.

In the apparatus according to the sixteenth aspect, if the apparatus comprises the splitter, the first transmitter may comprise third transmitter configured to transmit instances of the first signal part to a relay node of the communication network, and fourth transmitter configured to transmit instances of the fourth signal part to the relay node, the apparatus may comprise further prohibitor configured to prohibit the second transmitter from transmitting an instance of the fourth signal part at a predetermined time.

According to an eighteenth aspect of the invention, there is provided a transceiver station comprising an apparatus according to the sixteenth or seventeenth aspect.

According to a nineteenth aspect of the invention, there is provided a system comprising a first apparatus according to any of the thirteenth, fourteenth, and fifteenth aspect and a second apparatus according to any of the sixteenth, seventeenth, and eighteenth aspect, wherein, if the first apparatus comprises the splitter, the second apparatus comprises the combiner, and the splitter of the first apparatus is configured to split an instance of an uplink signal into an instance of the second signal part and an instance of the third signal part, and the combiner of the second apparatus is configured to combine the instance of the sec. and signal part and the instance of the third signal part into the instance of the uplink signal; and wherein, if the first apparatus comprises the combiner, the second apparatus comprises the splitter, and the splitter of the second apparatus is configured to split an instance of the downlink signal into an instance of the first signal part and an instance of the fourth signal part, and the combiner of the first apparatus is configured to combine the instance of the first signal part and the instance of the fourth signal part into the instance of the downlink signal.

It is to be understood that any of the above modifications can be applied singly or in combination to the respective aspects to which they refer, unless they are explicitly stated as excluding alternatives.

In particular, according to some embodiments,
the first signal may be a downlink backhaul signal,
the second signal may be an uplink backhaul signal,
the third signal may be an uplink access signal,
the fourth signal may be a downlink access signal,
the first signal part may be a part of the downlink backhaul signal which is transmitted inband or in full-duplex mode,
the second signal part may be a part of the uplink backhaul signal which is transmitted inband or in full-duplex mode,
the third signal part may be a part of the uplink backhaul signal which is transmitted outband or in half-duplex mode, and
the fourth signal part may be a part of the downlink backhaul signal which is transmitted outband or in half-duplex mode.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows an arrangement of subframes of backhaul and access subframes and their status;

FIG. 2 shows a system according to an embodiment of the invention including a DeNB according to an embodiment of the invention and a relay node according to the invention.

FIG. 3 shows a system according to an embodiment of the invention including a DeNB according to an embodiment of the invention and a relay node according to the invention.

FIG. 4a shows methods of downlink transmission and reception according to embodiments of the invention;

FIG. 4b shows methods of uplink transmission and reception according to embodiments of the invention;

FIG. 5a shows methods of downlink transmission and reception according to embodiments of the invention;

FIG. 5b shows methods of uplink transmission and reception according to embodiments of the invention;

FIG. 6 shows a system according to an embodiment of the invention;

FIG. 7 shows time and frequency bands and their occupation according to an embodiment of the invention;

FIG. 8 shows time and frequency bands and their occupation according to another embodiment of the invention;

FIG. 9 shows symbols of a subframe according to the prior art; and

FIG. 10 shows symbols of a subframe according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

Although 3GPP defines outband and inband relay, it still can not cover all relay deployment scenarios. For example, if there is sufficient isolation in spatial (or frequency) domain between backhaul link and access link, inband relay can also support full duplex transmission, and the backhaul link can also reuse the Rel8 UE channels. On the contrary, if frequency isolation is not sufficient, outband relay can not work at full duplex transmission mode, and MBSFN subframe and new control backhaul link control channel should be used.

Furthermore, Rel8 control channel's required received (Rx) signal to interference plus noise ratio (SINR) is always lower than traffic channel's RX SINR because a lower modulation and coding scheme (MCS) is used in the control channel. Thus, the control channel in backhaul link is more robust against the loop back interference which is generated by the transmitter in access link and vice versa. Consequently, in some scenarios, a relay node can work at full duplex mode for the control channel. It means in detail that the RN can receive the physical dedicated control channel (PDCCH) from the DeNB and transmit to r-UE PDCCH or MBSFN control symbols simultaneously.

However, such a RN may not work at full duplex mode for the traffic channel. That is, the RN can not receive physical dedicated shared channel (PDSCH) on the backhaul link correctly while it performs transmission in access link because a higher MCS is used in PDSCH and a higher RX SINR is needed for correct decoding. As traffic channels usually use higher MCS than control channels in backhaul link, the isolation requirement is high. For example, considering the SINR difference between a control channel such as PDCCH with 8 control channel elements (CCE), quadrature phase shift keying (QPSK), and a traffic channel such as PDSCH with 64QAM (quadrature amplitude modulation), ¾ coding rate, the SINR difference is more than 15 dB.

According to some embodiments of the invention, some schemes are provided where RN works at a mixture of half duplex and full duplex mode or at a mixture of inband and outband operation.

According to many embodiments, outband operation and full duplex mode go along with each other, and inband operation and half-duplex mode go along with each other. However, this is not necessary. For example, if the spatial separation between backhaul and access link is sufficient, a more robust part of the signal (e.g. the control signal) may be transmitted inband and in full duplex mode, while the remaining part of the signal is transmitted inband in half duplex mode. That is, the configuration is pure inband and mixture of half-duplex and full duplex mode. From a budget point of view, additional time is required until the trans-missions on backhaul and access links are finished due to the half-duplex mode.

On the other hand, under the same or similar conditions, the more robust part may be transmitted inband and in full duplex mode, while the remaining part of the signal is transmitted outband in full duplex mode. That is, the configuration is a mixture of inband and outband in full duplex mode. From a budget point of view, additional frequency band is required for the transmission on backhaul link because of the outband operation.

To be more general, the collision problem at the relay node may be solved by adding additional time budget or by adding additional frequency for a part of the backhaul signal. However, in contrast to an entire half-duplex mode, it is added only a minimum additional time for specific signal parts, and in contrast to an operation in an entire outband mode, it is added only a minimum required frequency budget for such specific signal parts.

For example, according to one scheme, the RN performs full duplex transmission for the bits of UL traffic channels and performs half duplex transmission for the bits of control channels. Thus, the HARQ collision issue in inband RN only mode is solved.

According to another scheme, RN performs full duplex transmission for the bits of the control channels (control signal) and performs half duplex transmission for the bits of the traffic channels (data signal). This scheme will improve signaling efficiency, and reduce the signaling cost and RN development complexity.

According to these schemes, the systems work in a mixture of full duplex and half duplex mode.

In both above schemes, full duplex operation may be performed if the corresponding parts are robust enough against self interference loop in inband mode, or if the corresponding signal parts are transmitted outband on the access link. Scheduling of the outband frequency band may be performed by higher layers. For example for the first proposal hereinabove, higher layer signaling a separate carrier C2 is used for solving the collision issues in inband scheme so that UL backhaul data transmission is scheduled on C2. This kind of configuration at relay makes the system to be a mixed system of inband and outband, i.e., at the non-collision subframes the relay is operating on inband mode, and for those subframes with HARQ collision problems the relay is operating on outband mode.

In prior art systems (e.g. 3GPP R1-100340) a pure inband RN is assumed and RN forwards the data in the chain eNB-RN-UE from one end to another end using two distant time slots in one subframe to solve the HARQ collision problem with the drawbacks as described above. In 3GPP R1-091332 and WO 2009/149565, the cross-carrier signaling or higher layer signaling issue for solving the HARQ collision problem is not mentioned.

For the second scheme, RN works at full duplex mode for control channel which is more robust than the data channel. It means RN may receive PDCCH from DeNB and transmit MBFSN control symbols simultaneously. But RN works at half duplex mode for the traffic channel. It means RN may receive R-PDSCH in backhaul link during the gap generated by the MBFSN frame.

An indication on the used outband carrier component for backhaul data transmission and/or backhaul control trans-mission may be included in the media access control/radio resource control (MAC/RRC) signaling. The indication may be explicit or implicit. For example, if the indication is done explicitly, the information elements in the RRC/MAC message may include one, some or all of those: component carrier(s) indication, DL/UL data and/or traffic transmission indication, time slot indication (may be omitted if the HARQ collision occurs in fixed or predetermined positions).

The additional (outband) carrier component could be contiguous or non-contiguous to the primary (inband) carrier component. Scheme 1 may be utilized for both TDD and FDD even it may be preferably utilized for TDD, as the HARQ collision problem is more serious with limited UL/DL resources in TDD.

Compared to the solution according to 3GPP R1-100340, embodiments of the present invention provide an optimized solution by making use of the fact that relay can operate on two carriers when it is on outband mode on one side, and may have the same RN complexity when it operates in inband mode, thereby improving the shortcomings in inband relay and solving the HARQ collision problem.

Embodiments of the present invention differ from the proposals according to 3GPP R1-091332 and WO 2009/149565 in that outband is a must feature for a mixture inband/outband relay and with such a conditional assumption, we propose the physical layer and/or higher layer signaling issue to solve the HARQ collision problem, and inband/outband mixture relay optimized scheme for backhaul signaling.

Currently, a relay scheme with a mixture of full duplex and half duplex mode or a mixture of inband and outband operation is not known to the applicant.

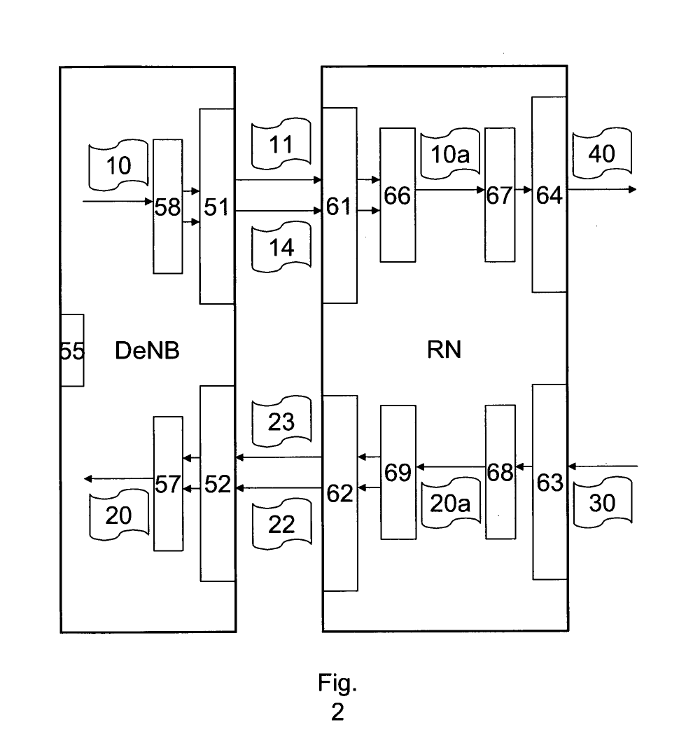

FIG. 2 shows a system according to an embodiment of the invention including a donor eNodeB (DeNB) according to an embodiment of the invention and a relay node (RN) according to an embodiment of the invention.

The DeNB comprises a base station processor 55 configured to provide base station functionality like communication with a corresponding controller (e.g. RNC) and executing instructions received from the controller. The DeNB may communicate with user equipment within its coverage area.

In addition, the DeNB may be operably connected to a relay node (RN). For that purpose, in the embodiment of FIG. 2, the DeNB comprises a transmitter 51 and a receiver 52. Connected to these entities, there are a splitter 58 and a combiner 57, respectively.

In the splitter 58, a downlink signal 10 to be transmitted to the RN is split into a first signal part 11 and the remaining signal part 14. The transmitter transmits the first signal part 11 on the downlink frequency band (inband downlink frequency band), and the remaining signal part 14 on a different frequency band (outband downlink frequency band). The splitter is configured such that collisions caused e.g. by HARQ requests and responses are avoided at the RN. Some potential splitting rules are discussed below in the detailed description of some embodiments.

The receiver 52 of the DeNB is configured to receive a signal from the RN. A signal part 22 of the signal may be received in the uplink frequency band (inband uplink frequency band), and the remaining signal part 23 in a different frequency band (outband uplink frequency band). These signal parts are fed into the combiner 57 which combines them to the uplink signal 20 for further processing by the DeNB, e.g. by processor 55.

The RN comprises a receiver 61 adapted to receive a first signal part 11 of a downlink signal in the inband downlink frequency band and the remaining signal part 14 of the downlink signal in a different frequency band (outband). These signal parts are fed into the combiner 66 which combines them to the downlink signal 10a for further processing by the RN.

In particular, the downlink signal 10a may be relayed by the relay unit 67 to a transmitter 64 adapted to transmit the relayed downlink signal 40 to a user equipment.

For the opposite direction of a signal flow, the RN comprises a receiver 63 adapted to receive an uplink signal 30 from a user equipment. The transmitter 64 and the receiver 63 may operate in one of frequency bands (inband downlink frequency band and inband uplink frequency band) as the transmitter 54 and receiver 53 of the DeNB, respectively.

The uplink signal 30 received by the receiver 63 may be relayed by relay unit 68 to a splitter 69. The splitter 69 splits the relayed uplink signal 20a into a first signal part 22 and a remaining signal part 23. The transmitter transmits the first signal part of the relayed uplink signal in the inband uplink frequency band, and the remaining signal part of the relayed uplink signal in a frequency band different from the inband uplink frequency band, that is an outband uplink frequency band.

The signal parts 22 and 23 may be received by receiver 52 of the DeNB. In the combiner 57, these signal parts are combined to an uplink signal 20, which may be further processed.

In the embodiment shown in FIG. 2, the DeNB and the RN comprise both, a combiner and a splitter. In other embodiments, the DeNB may comprise only one of the combiner 57 and the splitter 58. If the DeNB does not comprise the splitter, it may transmit a signal to the RN via a transmitter operating on one of the inband downlink frequency band and a different frequency band (outband). If the DeNB does not comprise the combiner, it may receive a signal from the RN via a receiver operating on one of the inband uplink frequency band and a different frequency band (outband).

Correspondingly, if in some embodiments the DeNB does not comprise a splitter, the RN of these embodiments may not comprise a combiner 66, and it may receive a signal from the DeNB via a receiver operating on one of the inband downlink frequency band and a different frequency band (outband). If the DeNB does not comprise a combiner, the RN of these embodiments may not comprise a splitter 69, and it may transmit a signal to the DeNB via a transmitter operating on one of the inband uplink frequency band and a different frequency band (outband).

FIG. 3 shows another system according to an embodiment of the invention including a donor eNodeB (DeNB) according to an embodiment of the invention and a relay node (RN) according to an embodiment of the invention.

The DeNB comprises a base station processor 55 configured to provide base station functionality like communication with a corresponding controller (e.g. RNC) and executing instructions received from the controller. The DeNB may communicate with user equipment within its coverage area.

In addition, the DeNB may be operably connected to a relay node (RN). For that purpose, in the embodiment of FIG. 3, the DeNB comprises transmitters 151 and 152 and receivers 153, 154. Connected to these entities, there are a splitter 158 and a combiner 157, respectively.

In the splitter 158, a downlink signal 10 to be transmitted to the RN is split into a first signal part 11 and the remaining signal part 14. The transmitter 151 transmits the first signal part 11, and the transmitter 152 transmits the remaining signal part 14.

While transmitter 151 may always transmit the first signal part 11 (full duplex operation), transmitter 152 may transmit only at predetermined times and is prohibited by the prohibitor 155 to transmit at other times (half duplex operation). The times of permission and prohibition and are selected such that collisions e.g. by HARQ requests and responses are avoided. Correspondingly, the splitter is configured such that signal parts that may cause collisions e.g. by HARQ requests and responses are comprised by the remaining signal part 14. In general, the same splitting rules as for the embodiment according to FIG. 2 may be applied here.

The RN comprises receivers 161 and 162 adapted to receive a first signal part 11 of a downlink signal and the remaining signal part 14 of the downlink signal, respectively. These signal parts are fed into the combiner 163 which combines them to the downlink signal 10a for further processing by the RN.

In particular, the downlink signal 10a may be relayed by the relay unit 164 to a transmitter 165 adapted to transmit the relayed downlink signal 40 to a user equipment.

While receiver 161 may always receive the first signal part 11 (full-duplex operation), in order to avoid self-interference, receiver 162 may receive the remaining signal part 14 only at predetermined time, as determined by prohibitor 166. That is, receiver 162 is permitted to receive the remaining signal part 14 only at times when the transmitter 165 is not permitted by the prohibitor 166 to transmit a downlink signal 40 which is based on the remaining signal part 14, and vice versa (half-duplex operation for this signal part). On the other hand, the transmitter 165 may always transmit a signal which is only based on the first signal part or generated by the relay node itself (full duplex operation for the first signal part).

For the opposite direction of a signal flow, the RN comprises a receiver 171 adapted to receive an uplink signal 30 from a user equipment.

The uplink signal 30 received by the receiver 171 may be relayed by relay unit 172 to a splitter 173. The splitter 69 splits the relayed uplink signal 20a into a first signal part 22 and a remaining signal part 23. The transmitter 175 transmits the first signal part 22 of the relayed uplink signal, and the transmitter 174 transmits the remaining signal part 23 of the relayed uplink signal.

The splitting in the splitter 173 is performed such that signal parts that may cause a collision with the uplink signal 30 are comprised by the remaining signal part 23. Thus, the transmitter 175 may always transmit the first signal part 22 (full duplex operation for the first signal part). On the other hand, the transmitter 174 is only permitted by the prohibitor 176 to transmit the remaining signal part 23 if the receiver 171 is prohibited by the prohibitor 176 to receive an uplink signal, and vice versa (half duplex operation for the remaining signal part).

The signal parts 22 and 23 may be received by receivers 153, 154 of the DeNB. In the combiner 57, these signal parts may be combined to an uplink signal 20, which may be further processed by the DeNB, e.g. by processor 55.

In the embodiment shown in FIG. 3, the DeNB and the RN comprise both, a combiner and a splitter. In other embodiments, the DeNB may comprise only one of the combiner and the splitter. If the DeNB does not comprise the splitter, it comprises only one transmitter, and if it does not comprise the combiner, it comprises only one receiver. Depending on the configuration, this one transmitter and combiner, respectively, may operate in a full-duplex or a half-duplex mode.

Correspondingly, if in some embodiments the DeNB does not comprise a splitter, the RN of these embodiments may not comprise a combiner, and may comprise only one receiver. If the DeNB does not comprise a combiner, the RN of these embodiments may not comprise a splitter, and may comprise only one transmitter. This one receiver and transmitter, respectively, may operate in a full-duplex or a half-duplex mode.

In order to avoid that an uplink signal 30 arrives at the receiver 171 of the RN at times when reception is forbidden, the RN may transmit a signal to the UEs which instructs the UEs to transmit an uplink signal at these times.

In a system like that shown in FIG. 3, it is preferable that the times when the prohibitor 155 of the DeNB permits/prohibits transmission of the remaining signal part 14 are aligned with the times when the prohibitor 166 permits/prohibits receipt of the remaining signal part.

In the uplink direction, a prohibition module corresponding to prohibitors 155, 166, and 176 in the DeNB is not required according to some embodiments because the RN takes care of the half-duplex operation. However, in some embodiments, such a further prohibition module may be comprised.

The functionality of the prohibitor may be integrated into the scheduling functionality of the DeNB or of the RN. This is beneficial as scheduling functionality is typically implemented in the DeNB and RN anyhow.

Combiners according to embodiments of the invention receive different signal parts of a signal and recover the information of the signal from these signal parts. For this information recovery, the parts may be combined before the further processing (such as decoding or relaying) of the signal. Alternatively, if e.g. one part comprises control information and the other part comprises data, one part (typically the control part) may be processed (decoded) independently first and the other part may be decoded depending on the result of the decoding of the first part.

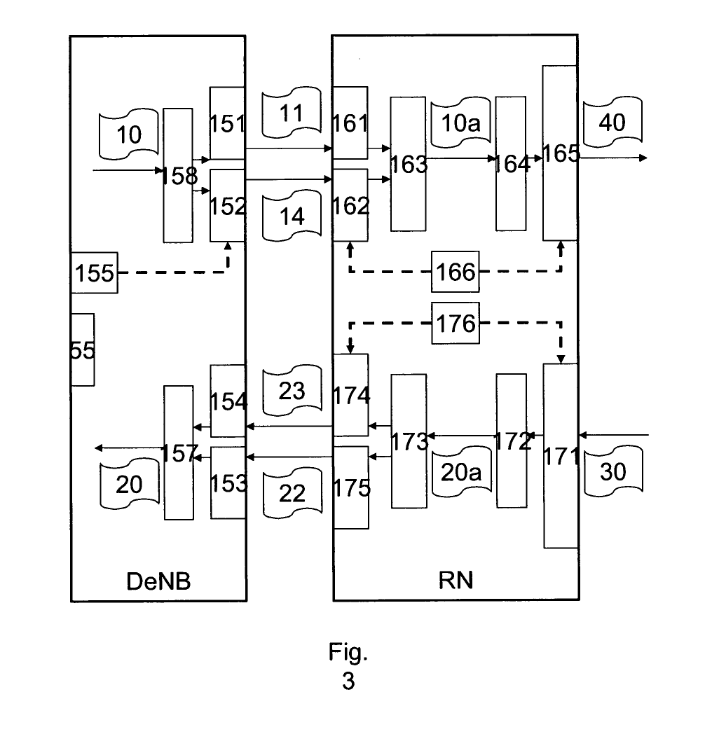

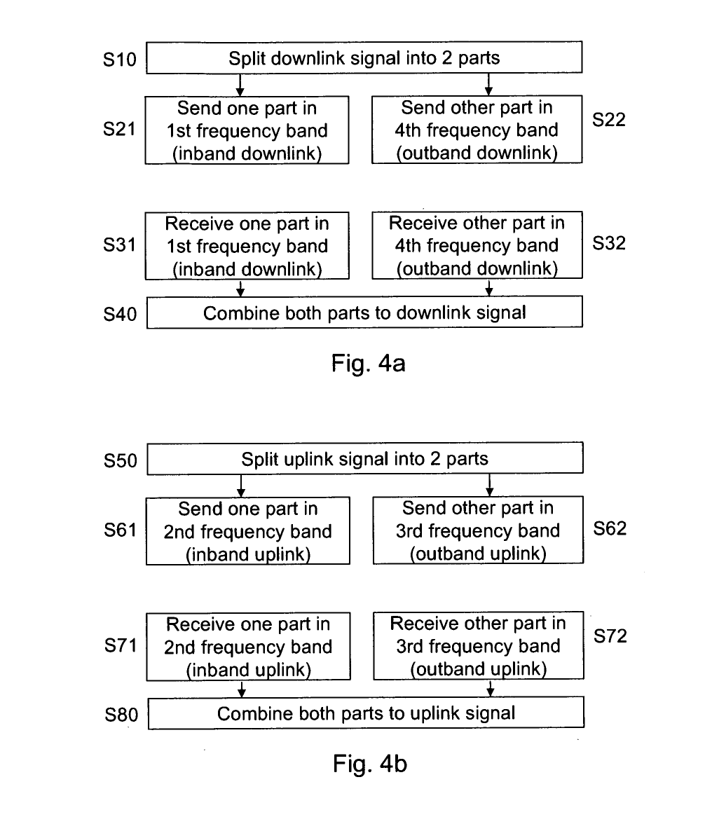

Methods according to some embodiments are shown in FIGS. 4a and 4b. In particular, FIG. 4a shows methods of an embodiment of relaying a downlink signal, and FIG. 4b shows methods of an embodiment relaying an uplink signal.

In step S10 of FIG. 4a, a downlink signal is split into two signal parts. According to steps S21 and S22, one signal part is transmitted in the inband downlink frequency band, and the other signal part in a different frequency band (outband).

On the other hand, in steps S31 and S32, the one signal part and the other signal part of the downlink signal are received. In step S40, the one signal part and the other signal part are combined to the downlink signal again.

In step S50 of FIG. 4b, an uplink signal is split into two signal parts. According to steps S61 and S62, one signal part is transmitted in the inband uplink frequency band, and the other signal part in a different frequency band (outband).

On the other hand, in steps S71 and S72, the one signal part and the other signal part of the signal are received. In step S80, the one signal part and the other signal part are combined to the uplink signal again.

According to some embodiments, a method may comprise one, some, or all of the respective step combinations (S10, S21, S22), (S31, S32, S40), (S50, S61, S62), and (S71, S72, S80).

Furthermore, step combinations (S10, S21, S22) and (S71, S72, S80) may be performed by an apparatus according to any of the fourth, fifth, sixth, sixteenth, seventeenth, and eighteenth aspect of the invention, in particular a donor eNodeB (DeNB) such as the one shown in FIG. 2. Step combinations (S31, S32, S40) and (S50, S61, S62) may be performed by an apparatus according to any of the first, second, third, thirteenth, fourteenth, and fifteenth aspect of the invention, in particular a relay node (RN) such as the one shown in FIG. 2.

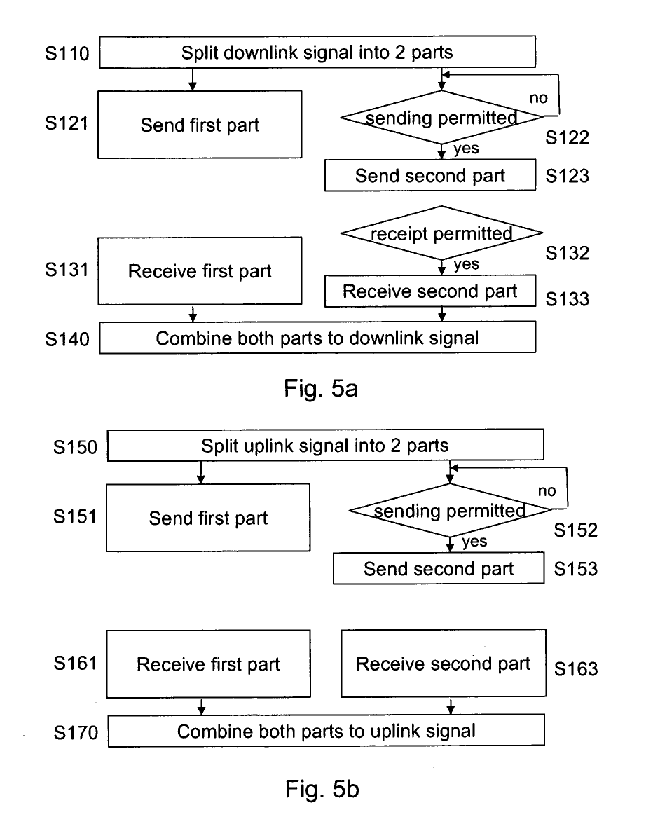

Methods according to some further embodiments are shown in FIGS. 5a and 5b. In particular, FIG. 5a shows methods of an embodiment of relaying a downlink signal, and FIG. 5b shows methods of an embodiment relaying an uplink signal.

In step S110 of FIG. 5a, a downlink signal is split into two signal parts. According to steps S121 one signal part is unconditionally transmitted (full duplex operation). For the other signal part, it is first checked in step S122, whether sending is permitted. If it is permitted, the other signal part is transmitted in step S123 (half duplex operation).

In steps S131, the one signal part of the downlink signal is unconditionally received (full duplex operation). For the other signal part, it is checked in step 132, if reception is allowed. If reception is allowed, the other signal part is received in step S133. In step S140, the one signal part and the other signal part are combined to the downlink signal again.

In step S150 of FIG. 5b, an uplink signal is split into two signal parts. According to steps S151 one signal part is unconditionally transmitted (full duplex operation). For the other signal part, it is first checked in step S152, whether sending is permitted. If it is permitted, the other signal part is transmitted in step S153 (half duplex operation).

On the other hand, in steps S161 and S163, the one signal part and the other signal part of the signal are received.

In step S170, the one signal part and the other signal part are combined to the uplink signal again.

According to some embodiments, a method may comprise one, some, or all of the respective step combinations (S110, S121, S122, S123), (S131, S132, S133, S140), (S150, S151, S152, S153), and (S161, S163, S170).

Furthermore, step combinations (S110, S121, S122, S123) and (S161, S163, S170) may be performed by an apparatus according to any of the fourth, fifth, sixth, sixteenth, seventeenth, and eighteenth aspect of the invention, in particular a donor eNodeB (DeNB) such as the one shown in FIG. 3. Step combinations (S131, S132, S133, S140) and (S150, S151, S152, S153) may be performed by an apparatus according to any of the first, second, third, thirteenth, fourteenth, and fifteenth aspect of the invention, in particular a relay node (RN) such as the one shown in FIG. 3.

In the following, certain embodiments of the present invention are explained at a greater detail:

In the following, some potential technical implementations of the first scheme, wherein the RN performs a mixture of inband and outband transmission for the bits of UL traffic channels and performs inband transmission for the bits of control channels, are described.

According to this scheme, eNB and RN may operate on two component carriers (CCs) that have a sufficient frequency distance between the channel bandwidth edges so that eNB and RN can receive and transmit on the two CCs at the same time. The two CCs may be backwards compatible with 3GPP Rel-8 or not. FIGS. 4, 5 and 6 illustrate the configuration of the radio links.

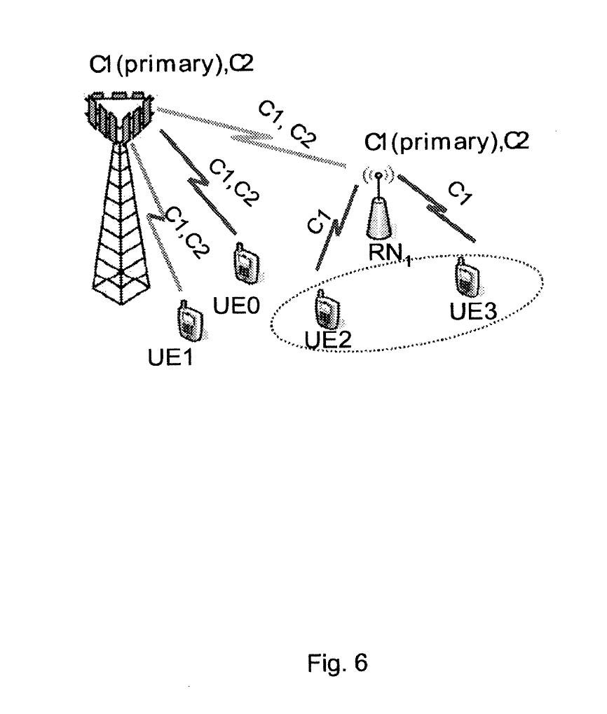

According to FIG. 6, component carrier C1 is configured as primary carrier (inband carrier) mainly used for backhaul communication. An aggregated carrier C2 (outband carrier) different from the inband carrier may be used for relay UL or DL backhaul transmissions when there might be a collision between backhaul and access links transmission.

For the scheme 1 we have two scenarios as described below:

### Scheme 1, Scenario 1:

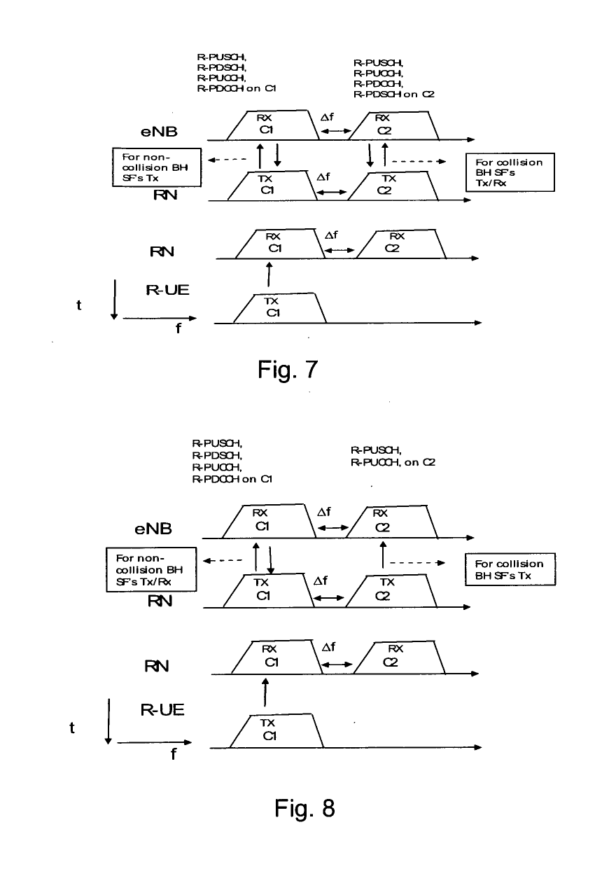

As shown in FIG. 7, subframes (0, 1, 5, 6) for TDD and (0, 4, 5, 9) for FDD, respectively, may be enabled for backhaul DL transmission on C2. In FDD, UL subframes that are related with (0, 4, 5, 9) will be scheduled on C2.

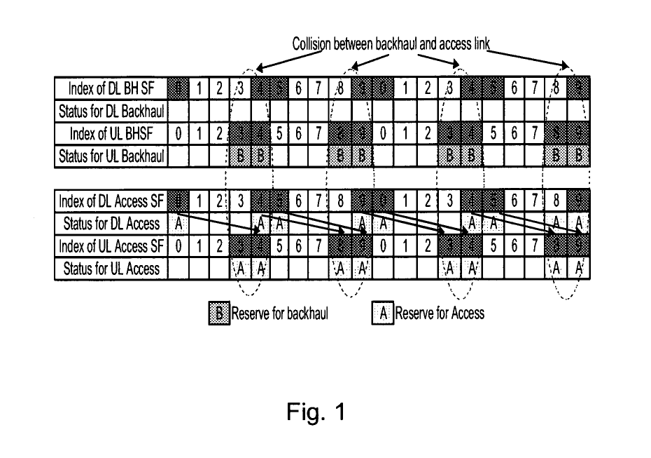

Assuming that an implicit resource partitioning method was used for FDD, eNB knows the relay frame format and the potential HARQ collision problem with the number of the subframes. Thus, according to scenario 1, the HARQ collision problem as described in FIG. 1 may be solved. For example, an eNB may know from FIG. 1 that the subframes #3, 4, 8, 9 may have the backhaul and access collision problem. Accordingly, the eNB would schedule relay backhaul DL transmission for #0, 4, 5, 9 at C2 and RN transmits UL backhaul for #3, 4, 8, 9 at C2 to eNB. The corresponding UL resources assignment may be done by R-PDCCH at C2 subframe n and corresponding R-PUSCH at C2 subframe n+4, i.e., subframes #3, 4, 8, 9. Alternatively, it may be done by higher layer MAC/RRC signaling. Since eNB-eUE, RN-rUE communication of these non-MBSFN subframes are in C2 and eNB-RN communication of these special subframes are in C2, as a result, all backhaul link operation of these non-MBSFN subframes may be scheduled in outband mode.

According to scenario 1 of scheme 1, non-MBSFN subframes (0, 1, 5, 6) for TDD and (0, 4, 5, 9) for FDD, respectively, are enabled for backhaul transmission and the HARQ collision issues in subframes that are related to non-MBSFN subframes are solved.

C2 should preferably be a narrow band carrier that can be used for backhaul transmission without UE camped on.

### Scheme 1, Scenario 2:

All DL backhaul signaling will be on primary carrier C1, and for those with HARQ collision problem UL subframes the UL backhaul transmission will be scheduled on C2, as FIG. 6 illustrates. Scheduling may be performed by using DL cross-carrier scheduling on C1 or by higher layer MAC/RRC signaling.

In order to use cross-carrier scheduling for the R-PDCCH a carrier indicator field (CIF) may be additionally included into R-PDCCH payload. The CIF may work similarly as the CIF field in the regular PDCCH by indicating with e.g. 3 bits the target component carrier which indicates one CC only.

Cross-carrier scheduling for the RN gives an additional flexibility and makes it possible to dynamically avoid the HARQ problem for certain subframes.

When eNB detects that there would be a collision between backhaul and access links, it schedules a grant on C1 R-PDCCH with the indication of C2 by means of CIF at the subframe n so RN would know about the specific subframe to transmit data accordingly. Thus the collision problems could be avoided.

Using DL cross-carrier signaling it is such that DL control signaling operates on inband mode that assigns UL resources for UL data transmission for those collided subframes at a different frequency band; and UL data transmission operates on outband mode at backhaul for those collided subframes.

Scenario 2 is preferred for solving HARQ collision problems in subframes except non-MBSFN subframes (0, 1, 5, 6) for TDD and (0, 4, 5, 9) for FDD.

Usage of CIF may be avoided with an implicit scheme: Both eNB and RN may know when there are subframes that are not available for backhaul because of collision problems. A convention may be used that any grants that refer to the non-backhaul subframes on C1 actually refer to C2. Then CIF is not needed, because the information of the CIF is available implicitly.

This implicit scheduling would avoid the necessity of the CIF and the corresponding overhead and would allow using a single downlink control information (DCI) format only. On the other hand, the ability is lost to schedule freely information on either C1 or C2. However, the mixed mode is in particular useful if C1 is preferred carrier for backhaul (e.g. there may be more capacity on C1 compared to C2) and C2 is used only if unavoidable.

Another option for scenario's 1&2 scheduling of UL data transmission on C2 can be done by including a few new bits in RRC/MAC layer message for indicating, for example component carrier(s) indication, DL/UL data, time slot indication (may be omitted if the HARQ collision occurs in fixed positions). The RRC/MAC signalling could be periodically or event triggered.

Scenario 2 might be useful for TDD with explicitly resource scheduling, if it is regarded that the HARQ collision problem cannot be avoided with explicit resource scheduling. This might be the case if only one UL resource is available and the one UL resource might be mapped to several DL subframes' ACK/NACK signaling. Scenario 2 may be also applicable for FDD when the collision is caused by different periodicity of MBSFN subframe signalling and HARQ. In this case the RN would perform inband scheme on UL subframes without collision problem, and relay would use cross-carrier scheduling for those subframes with the problem of HARQ collision and perform an outband relay backhaul operation on those UL subframes.

Since C2 may be scheduled only for relay backhaul transmission if there is HARQ collision between access links and backhaul links, there should be still some resources available for macro-UE camping. Thus, if scenario 2 is used for mixed inband and outband relay, C2 may also camp macro-UEs (UEs connected to the eNB instead of the RN) to average the system load of eNB.

Note that multiple RNs can use different subframes for backhaul communication on C2 and complementary subframes on C2. In this way it is possible to balance the traffic on C2 over the different subframes, i.e. there is always a substantially constant traffic on C2.

If UL control signal and UL data signal may be transmitted simultaneously, as it is planned for 3GPP Release 10, subframes of collision of the UL control signal may be scheduled to C2. This results in scenarios slightly modified over those discussed above (scenarios 1.b and 2.b).

### Scheme 2:

According to scheme 2, RN, preferably applicable for inband Relay, performs full duplex transmission for the bits of the control channels (control signal) and performs half duplex transmission for the bits of the traffic channels (data signal).

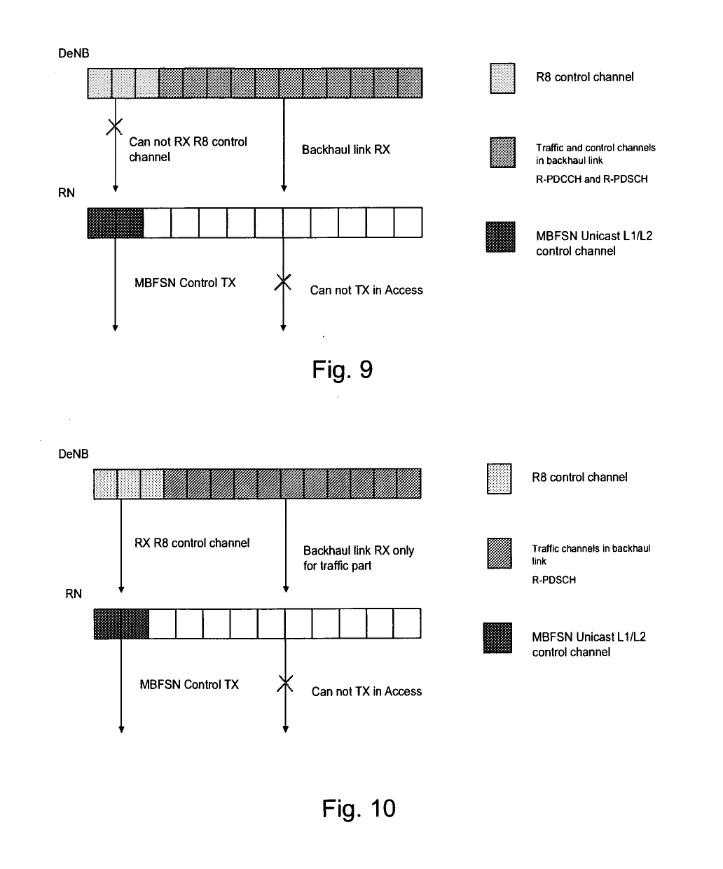

FIG. 9 shows an example of symbols in a downlink subframe for backhaul transmission according to the prior art. Each box represents a symbol. The upper row shows a downlink subframe of a DeNB, and the lower row a downlink subframe of the RN. There are 14 of symbols available from #0-#13 for DeNB TX in the example figure, first 3 symbols are for Rel8 PDCCH (control signal) and the last 11 symbols are for backhaul transmission. But usually less symbols can be used for the backhaul transmission due to RN switching time. In the embodiment according to FIG. 9, first 2 symbols of the downlink subframe of the RN are used for MBFSN Unicast L1/L2 control channel transmission.

According to FIG. 9, the control signals are transmitted in a pure half duplex in-band mode. Since the RN cannot receive the PDCCH, the R-PDCCH (relay-PDCCH) is needed in the backhaul transmission (and also R-PDSCH). In FIG. 9, the left symbols for the DeNB are for PDCCH control signal transmission; and the right boxes are for inband backhaul R-PDCCH and R-PDSCH at one eNB. RN cannot receive PDCCH that is for Macro UE according to FIG. 9, when RN is transmitting the control channel of MBFSN frame. At the same time, when RN is receiving transmission R-PDCCH or R-PDSCH at backhaul link (eNB-RN), RN can not transmit in access link.

FIG. 10 corresponds to FIG. 9, but shows a subframe according to an embodiment of the invention. I.e., according to FIG. 10 the RN can receive the PDCCH, and R-PDCCH is not needed in the backhaul transmission. Only R-PDSCH is required on the backhaul link.

According to FIG. 10, since RN is working on a mixture mode of inband and outband, RN is able to receive the control channel PDCCH from DeNB, and also transmit the MBFSN control channel using the first 2 symbols of the downlink subframe of the RN.

As the PDCCH may be reused for mixture duplex inband RN, then the control signaling problems raised by pure half duplex inband RN are solved naturally.

FIGS. 9 and 10 relate to 3GPP release 8 (Rel8), however, other embodiments may be implemented according to other releases.

### Scheme 3:

According to a third scheme, RN performs half duplex trans-mission for the bits of the control channels (control signal) and performs full duplex transmission for the bits of the traffic channels (data signal). This scheme will improve data transfer at the cost of signaling efficiency.

The following table 1 shows a summary of the different backhaul schemes and scenarios discussed above. Table 1 is not exhaustive and other schemes and scenarios may fall under the scope of the present invention, too.

The advantages of the scheme 1 are:
Eliminating problems of losing HARQ information
Combined both inband and outband advantages
Backwards compatible with Rel-8 UEs.
make use of inband available schemes and maintain inband advantages
improve inband RN efficiency with outband feature assistance.

TABLE 1

| | DL control | DL data | UL control | UL data |
|---|---|---|---|---|
| Scheme 1 | inband or partly outband | inband or partly outband | inband or partly outband | partly outband |
| Scenario 1.a | SF (0, 4, 5, 9) FDD, SF | SF (0, 4, 5, 9) FDD, SF (0, 1, 5, 6) | inband | SF of collision: outband; |
| | (0, 1, 5, 6) TDD: outband; | TDD: outband; | | other SFs: inband |
| | other SFs: inband | other SFs: inband | | |
| Scenario 1.b | SF (0, 4, 5, 9) FDD, SF (0, 1, 5, 6) | SF (0, 4, 5, 9) FDD, SF (0, 1, 5, 6) | SF of collision: outband; | SF of collision: outband; |
| | TDD: outband; | TDD: outband; | other SFs: inband | other SFs: inband |
| | other SFs: inband | other SFs: inband | | |
| Scenario 2.a | Inband | Inband | inband | outband when collision is detected by |
| | | | | DeNB or for predetermined SFs; |
| | | | | other SFs: inband |
| Scenario 2.b | Inband | Inband | SF of collision: outband; | outband when collision is detected by |
| | | | other SFs: inband | DeNB or for predetermined SFs; |
| | | | | other SFs: inband |
| Scheme 2 | Outband | Inband | Outband | Inband |

The advantages of scheme 2 are:
Reduce the signaling cost in backhaul link
Reduce the development complexity
Lower the isolation requirement.

In these schemes we addressed outband vs. inband usage for different data channels in UL and DL. Alternatively, we can also use full and half duplex transmission. Typically full duplex transmission i.e. transferring data both on backhaul and access link simultaneously is applicable to outband and half duplex i.e. not transferring data both on backhaul and access link simultaneously but alternating is applicable for outband. Consequently, for most of the embodiments, the mixture of inband/outband by a mixture of full-duplex and half-duplex operation. Note that the term full/half duplex here relates to transferring information simultaneously on backhaul and access link, not necessarily on UL and DL (usually, in non-relay applications, the term full/half duplex relates to simultaneous transfer in both UL and DL)

However, there may be subtle differences sometimes, e.g. if some antenna separation is provided for the antennas used on both directions and consequently some isolation is provided, that is however often not perfect. Then it may be possible to transmit e.g. a control part in full duplex, accepting some self interference, while it is preferential to transmit a data part in half duplex to avoid the self interference. Note that both data and control are transmitted inband in this case. So in general the scenarios that are described in this application for using inband respectively outband can also be reused for corresponding scenarios using full- and half-duplex respectively, when substituting full duplex for outband and half duplex for inband.

According to the description of some embodiments hereinabove, potential collisions caused by the HARQ mechanism are avoided. However, the outband/inband mixing according to embodiments of the invention may be useful to avoid other potential collisions, too:

For example, outband/inband mixing could be also applicable to assign outband UL resources to backhaul if there is a lack of UL resources in the resources partitioning between backhaul link and access link in the RN. This might be of particular interest for the time division duplex (TDD) case, where some TDD frame formats may lack of UL resources. If the limited inband UL subframe is assigned for the access link RN to user equipment, the UL backhaul may be scheduled outband. As discussed above, this may be done through DL cross-carrier signaling or higher layer signaling.

Furthermore, the invention is not limited to the embodiments disclosed above. Depending on the circumstances, some part of the signalling between DeNB and RN and vice versa may be transmitted inband and another part outband. However, at least one of the downlink backhaul and the uplink backhaul may use both inband and outband frequency band.

In order to avoid interference, the inband uplink frequency band, outband uplink frequency band, inband downlink frequency band, and outband downlink frequency band should be different from each other, preferably with a gap between adjacent two of these frequency bands, more preferably between any adjacent two of these frequency bands.

Some embodiments of the invention are described according to an LTE system. However, other embodiments of the invention may belong to other wireless communication systems.

Several embodiments described herein work in the frequency division duplex (FDD) mode. In this mode, the uplink frequency bands of backhaul and access are different from the respective downlink frequency bands.

However, other embodiments may work in the time division duplex (TDD) mode. In this mode, uplink and downlink of backhaul and access, respectively, use the same frequency band but different time slots.

Some embodiments of the invention are described, whereto a user equipment is connected. However, any terminal that fits to the corresponding communication system may be used.

For some embodiments, a DeNB is described as a transceiver station. However, in other embodiments, the role of a transceiver station may be taken over by another base station or a terminal such as a user equipment of the corresponding communication system.

In some embodiments, the transceiver station may communicate with a terminal in one of the frequency band used for the respective backhaul link. In other embodiments, these frequency bands may be different.

In some embodiment, the downlink access signal may be sent by the relay node using the MBSFN subframe.

Some embodiments employ the present invention on the physical layer. Other embodiments may employ it on different layers of their communication system.

According to the above description, it should thus be apparent that exemplary embodiments of the present invention provide, for example a relay node, or a component thereof, an apparatus embodying the same, a method for controlling and/or operating the same, and computer program(s) controlling and/or operating the same as well as mediums carrying such computer program(s) and forming computer program product(s). Further exemplary embodiments of the present invention provide, for example a NodeB, or a component thereof, an apparatus embodying the same, a method for controlling and/or operating the same, and computer program(s) controlling and/or operating the same as well as mediums carrying such computer program(s) and forming computer program product(s)

For example, described above are apparatuses, methods, a system and computer program products wherein outband/inband mixture backhaul signaling is provided. In particular, it is provided an apparatus, comprising relaying means configured to form an instance of a fourth signal based on an instance of a first signal and to form an instance of a second signal based on an instance of a third signal; second receiving means configured to receive instances of the third signal from a terminal of a communication network in a second frequency band; and second transmitting means configured to transmit instances of the fourth signal to the terminal in a first frequency band; wherein the apparatus further comprises at least one of a combining means configured to combine an instance of a first signal part and an instance of a fourth signal part into an instance of the first signal and a splitting means configured to split an instance of the second signal into an instance of a second signal part and an instance of a third signal part; wherein, if the apparatus comprises the combining means, it comprises further first receiving means configured to receive an instance of the first signal part from a transceiver station of the communication network in the first frequency band, and to receive an instance of the fourth signal part in a fourth frequency band different from the first frequency band; and, if the apparatus comprises the splitting means, it comprises further first transmitting means configured to transmit an instance of the second signal part to the transceiver station in the second frequency band and to transmit an instance of the third signal part in a third frequency band different from the second frequency band.

For example, described above are apparatuses, methods, a system and computer program products wherein full-duplex/half-duplex mixture backhaul signaling is provided. In particular, it is provided an apparatus, comprising relaying means configured to form an instance of a fourth signal based on an instance of a first signal and to form an instance of a second signal based on an instance of a third signal; second receiving means configured to receive instances of the third signal from a terminal of a communication network; and second transmitting means configured to transmit instances of the fourth signal to the terminal; wherein the apparatus further comprises at least one of a combining means configured to combine an instance of the first signal part and an instance of the fourth signal part into an instance of the first signal and a splitting means configured to split an instance of the second signal into an instance of the second signal part and an instance of the third signal part; wherein, if the apparatus comprises the combining means, it comprises further third receiving means configured to receive instances of the first signal part from a transceiver station of the communication network, fourth receiving means configured to receive instances of the fourth signal part from the transceiver station, and, first prohibiting means configured to permit the second transmitting means to transmit an instance of the fourth signal which is based on an instance of the fourth signal part and to simultaneously prohibit the fourth receiving means to receive an instance of the fourth signal part, and configured to prohibit the second transmitting means to transmit an instance of the fourth signal which is based on an instance of the fourth signal part and to simultaneously permit the fourth receiving means to receive an instance of the fourth signal part; and wherein the second transmitting means is configured to transmit the instance of the fourth signal which is based on an instance of the fourth signal part only when it is permitted to; if the apparatus comprises the splitting means, it comprises further third transmitting means configured to transmit instances of the third signal part to the transceiver station, fourth transmitting means configured to transmit instances of the second signal part to the transceiver station, and second prohibiting means configured to permit the fourth receiving means to transmit an instance of the third signal part and to simultaneously prohibit the second receiving means to receive an instance of the third signal, and configured to prohibit the fourth receiving means to transmit an instance of the third signal part and to simultaneously permit the second receiving means to receive an instance of the third signal, and wherein the fourth transmitting means is configured to transmit the instance of the third signal part only when it is permitted to.

Furthermore, it is provided an apparatus, comprising transceiver station means configured to provide a transceiver station functionality of a communication network; wherein the apparatus further comprises at least one of a combining means configured to combine an instance of a second signal part and an instance of a third signal part into an instance of a second signal and a splitting means configured to split an instance of a first signal into an instance of a first signal part and an instance of a fourth signal part; and wherein, if the apparatus comprises the splitting means, it comprises further first transmitting means configured to transmit instances of the first signal part to a relay node of the communication network in a first frequency band and to transmit instances of the fourth signal part in a fourth frequency band different from the first frequency band; and, if the apparatus comprises the combining means, it comprises further first receiving means configured to receive instances of the second signal part from the relay node in a second frequency band, and to receive instances of the third signal part in a third frequency band different from the second frequency band.

Still furthermore, it is provided an apparatus, comprising transceiver station means configured to provide a transceiver station functionality of a communication network; wherein the apparatus further comprises at least one of a combining means configured to combine an instance of a second signal part and an instance of a third signal part into an instance of a second signal and a splitting means configured to split an instance of a first signal into an instance of a first signal part and an instance of a fourth signal part; and wherein, if the apparatus comprises the splitting means, it comprises further third transmitting means configured to transmit instances of the first signal part to a relay node of the communication network, fourth transmitting means configured to transmit instances of the fourth signal part to the relay node, and prohibiting means configured to prohibit the fourth transmitting means from transmitting an instance of the fourth signal part at a predetermined time; and, if the apparatus comprises the combining means, it comprises further third receiving means configured to receive instances of the second signal part from the relay node, and fourth receiving means configured to receive instances of the third signal part.

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1-41. (canceled)

42. An apparatus, comprising:
at least one processor; and
at least one memory including computer program code
the at least one memory and the computer program code configured to, with the at least one processor, cause the apparatus to at least:
form an instance of a fourth signal based on an instance of a first signal and to form an instance of a second signal based on an instance of a third signal;
receive at a second receiver instances of the third signal from a terminal of a communication network in a second frequency band; and
transmit from a second transmitter instances of the fourth signal to the terminal in a first frequency band;
wherein the at least one memory and the computer program code further configured to, with the at least one processor, either cause the apparatus further to at least:
combine an instance of a first signal part and an instance of a fourth signal part into an instance of the first signal and receive at a first receiver an instance of the first signal part from a transceiver station of the communication network in the first frequency band, and to receive at the first receiver an instance of the fourth signal part in a fourth frequency band different from the first frequency band;
or cause the apparatus further to at least:
split an instance of the second signal into an instance of a second signal part and an instance of a third signal part and transmit from a first transmitter an instance of the second signal part to the transceiver station in the second frequency band and to transmit from the first transmitter an instance of the third signal part in a third frequency band different from the second frequency band.

43. An apparatus according to claim 42, wherein the second signal comprises a second control signal for controlling the transceiver station and a second data signal different from the second control signal; and
the second signal part of the second signal comprises a first fraction of the second data signal; and the third signal part of the second signal comprises a second fraction of the second data signal.

44. An apparatus according to claim 43, wherein the first fraction and the second fraction are predetermined.

45. An apparatus according to claim 42, the at least one memory and the computer program code further configured to, with the at least one processor, cause the apparatus to at least:
receive a splitting information from the transceiver station and split the second signal based on the splitting information.

46. An apparatus according to claim 45, wherein the splitting information is comprised in the first signal part or in a signaling of a higher protocol layer than a protocol layer of the first signal.

47. An apparatus according to claim 42, the at least one memory and the computer program code further configured to, with the at least one processor, cause the apparatus to at least:
if the apparatus is not caused to perform the combining, receive at the first receiver the first signal in one of the first frequency band and the fourth frequency band; and,
if the apparatus is not caused to perform the splitting, transmit from the first transmitter the second signal in one of the second frequency band and the third frequency band.

48. An apparatus according to claim 42, wherein,
if the apparatus is further caused to perform the splitting, the second signal comprises a second control signal for controlling the transceiver station and a second data signal different from the second control signal;
the second signal part of the second signal comprises either the second control signal or the second data signal; and
the third signal part of the second signal comprises the second control signal or second data signal which is not comprised in the second signal part; and
if the apparatus is further caused to perform the combining, the first signal comprises a first control signal for controlling the apparatus and a first data signal different from the first control signal;
the first signal part of the first signal comprises either the first control signal or the first data signal; and the fourth signal part of the first signal comprises the first control signal or the first data signal which is not comprised in the first signal part.

49. An apparatus according to any of the claim 42, wherein,
if the apparatus is further caused to perform the combining, the at least one memory and the computer program code further configured to, with the at least one processor, cause the apparatus to at least:
receive at the first receiver instances of the first signal part and instances of the fourth signal part and
prohibit the first receiver from receiving an instance of the fourth signal part only when the second transmitter transmits an instance of the fourth signal which is based on an instance of the fourth signal part; and
if the apparatus is further caused to perform the splitting, transmit from the first transmitter instances of the third signal part and instances of the second signal part and
prohibit the second receiver from receiving an instance of the third signal and to allow transmitting of an instance of the third signal part only when the second receiver is prohibited to receive an instance of the third signal.

50. An apparatus, comprising:
at least one processor; and
at least one memory including computer program code
the at least one memory and the computer program code configured to, with the at least one processor, cause the apparatus to at least:
form an instance of a fourth signal based on an instance of a first signal and to form an instance of a second signal based on an instance of a third signal;
receive at a second receiver instances of the third signal from a terminal of a communication network; and
transmit from a second transmitter instances of the fourth signal to the terminal;
wherein the at least one memory and the computer program code further configured to, with the at least one processor, either cause the apparatus further to at least:
combine an instance of the first signal part and an instance of the fourth signal part into an instance of the first signal, and
receive at a first receiver instances of the first signal part and instances of the fourth signal part from a transceiver station of the communication network, and
prohibit simultaneous transmission by the second transmitter of an instance of the fourth signal which is based on an instance of the fourth signal part and reception by the first receiver of an instance of the fourth signal part,
or cause the apparatus further to at least:
split an instance of the second signal into an instance of the second signal part and an instance of the third signal part and
transmit from a third transmitter instances of the third signal part and from a fourth transmitter instances of the second signal part to the transceiver station, and
prohibit simultaneous transmission by the fourth transmitter of an instance of the third part and reception by the second receiver of an instance of the third signal.

51. An apparatus according to claim 50, wherein the second signal comprises a second control signal for controlling the transceiver station and a second data signal different from the second control signal; and
the second signal part of the second signal comprises a first fraction of the second data signal; and the third signal part of the second signal comprises a second fraction of the second data signal.

52. An apparatus according to claim 51, wherein the first fraction and the second fraction are predetermined.

53. An apparatus according to claim 50, the at least one memory and the computer program code further configured to, with the at least one processor, cause the apparatus to at least:
receive a splitting information from the transceiver station split the second signal based on the splitting information.

54. An apparatus according to claim 53, wherein the splitting information is comprised in the first signal part or in a signaling of a higher protocol layer than a protocol layer of the first signal.

55. An apparatus according to claim 50, wherein
if the apparatus is further caused to perform the splitting, the second signal comprises a second control signal for controlling the transceiver station and a second data signal different from the second control signal;
the second signal part of the second signal comprises either the second control signal or the second data signal; and
the third signal part of the second signal comprises the second control signal or second data signal which is not comprised in the second signal part; and
if the apparatus is further caused to perform the combining, the first signal comprises a first control signal for controlling the apparatus and a first data signal different from the first control signal;
the first signal part of the first signal comprises either the first control signal or the first data signal; and the fourth signal part of the first signal comprises the first control signal or the first data signal which is not comprised in the first signal part.

56. An apparatus according to claim 50, wherein the at least one memory and the computer program code configured to, with the at least one processor, cause the apparatus to at least:
send, when reception by the second receiver of an instance of the third signal is prohibited, from the second transmitter a fifth signal to the terminal adapted to prohibit the terminal to send an instance of the third signal.

57. An method, comprising:
forming, by an apparatus, an instance of a fourth signal based on an instance of a first signal and to form an instance of a second signal based on an instance of a third signal;
receiving, by the apparatus, instances of the third signal from a terminal of a communication network in a second frequency band; and
transmitting, by the apparatus, instances of the fourth signal to the terminal in a first frequency band;
wherein the method further comprises at least one of:
combining an instance of a first signal part and an instance of a fourth signal part into an instance of the first signal and receiving an instance of the first signal part from a transceiver station of the communication network in the first frequency band, and receiving an instance of the fourth signal part in a fourth frequency band different from the first frequency band;
and
splitting an instance of the second signal into an instance of a second signal part and an instance of a third signal part and transmitting an instance of the second signal part to the transceiver station in the second frequency band and transmitting an instance of the third signal part in a third frequency band different from the second frequency band.

58. A method according to claim 57, wherein the second signal comprises a second control signal for controlling the transceiver station and a second data signal different from the second control signal; and
the second signal part of the second signal comprises a first fraction of the second data signal; and the third signal part of the second signal comprises a second fraction of the second data signal.

59. A method according to claim 58, wherein the first fraction and the second fraction are predetermined.

60. A method according to claim 57, further comprising
receiving a splitting information from the transceiver station and splitting the second signal based on the splitting information.

61. A method according to claim 60, wherein the splitting information is comprised in the first signal part or in a signaling of a higher protocol layer than a protocol layer of the first signal.
